(19) United States
(12) Patent Application Publication
(10) Pub. No.: US 2023/0339338 A1
(43) Pub. Date: Oct. 26, 2023

(54) CHARGING PARKING LOT

(71) Applicant: AUDI AG, Ingolstadt (DE)

(72) Inventors: Jürgen HORVATH, Pfakofen (DE); Franz LANKES, Ingolstadt (DE)

(21) Appl. No.: 18/139,144

(22) Filed: Apr. 25, 2023

(30) Foreign Application Priority Data
Apr. 26, 2022 (DE) 10 2022 109 968.7

(51) Int. Cl. B60L 53/12; H02J 7/35; H02J 7/00; H02J 50/10; H02J 50/40; H02J 50/90; B60L 53/30; B60L 53/51; B60L 53/53; B60L 53/66

(52) U.S. Cl. CPC B60L 53/12; H02J 7/35; H02J 7/0042; H02J 50/10; H02J 50/40; H02J 50/90; B60L 53/30; B60L 53/51; B60L 53/53; B60L 53/66

(57) ABSTRACT

A charging parking lot is provided for performing an electrical charging process for a vehicle, comprising at least one inductive charging interface, wherein the charging parking lot has multiple inductive charging zones, and each charging zone is either activatable or deactivatable, wherein the vehicle is to be parked on the charging parking lot in order to perform the charging process, wherein only that at least one charging zone of the charging parking lot is to be activated which is situated directly beneath the at least one inductive charging interface of the vehicle, wherein the at least one activated charging zone is adapted to generate a magnetic field for the transfer of electrical energy to the at least one inductive charging interface of the vehicle.

### BACKGROUND

### Technical Field

Embodiments of the present disclosure relate to a charging parking lot, a charging infrastructure, and a method for performing an electrical charging process for a vehicle.

### Description of the Related Art

In order to charge the drive battery of a vehicle, it is necessary to connect it to an energy source.

A wireless charging system for an electrical vehicle is described in document CN 111016692 A.

Document WO 2015/009482 A2 describes a system and a method for identifying an electrical vehicle and a charging station.

An autonomous wireless charging system for an electrical vehicle is known from document WO 2020/176860 A1.

### BRIEF SUMMARY

Embodiments of the invention described herein provide an electrical charging parking lot, or a two-dimensional and/or flat laid-out charging station, which is adapted to carry out an electrical charging process for a vehicle, such as a motor vehicle, or for a battery, such as a traction battery, of that vehicle. The vehicle comprises at least one inductive charging interface, usually at, in and/or on its bottom side. The charging parking lot comprises a charger plate composed of multiple inductive charging zones, each charging zone usually being either automatically activatable, to be activated, or activated, or alternatively being automatically deactivatable, to be deactivated, or deactivated. The vehicle is to be positioned or parked on the charging parking lot in order to carry out the charging process. Usually only that at least one charging zone of the charging parking lot is to be automatically activated which is situated directly beneath the at least one inductive charging interface of the vehicle and thus lies immediately underneath it. Only this at least one activated charging zone beneath the at least one charging interface is adapted to create a magnetic field during the charging process in order to transfer electrical energy to the at least one inductive charging interface of the vehicle situated above it.

In one embodiment, each inductive charging zone or a corresponding charging module is formed as a regular n-gon, such as a triangle, a quadrangle, usually a rectangle, such as a square, or a hexagon, and thus honeycomb-shaped, and is arranged in a subfloor or in the ground and/or installed and/or integrated in a foundation provided for this, level with the ground. The charging zones are arranged directly adjacent to each other, directly bounding on each other, mutually touching each other at the outer edges, in the form of a lattice in the charger plate, in at least one row and in at least one column, and they form a closed field of charging zones.

The charging parking lot comprises at least one, usually an optical sensor, such as a camera, which is adapted to register which at least one charging zone is situated directly beneath the at least one inductive charging interface of the vehicle and which zone is not, and accordingly which zone is to be automatically activated and which is not.

The charging infrastructure described herein is adapted to carry out electrical charging processes for vehicles, each vehicle having at least one inductive charging interface on its bottom side. The charging infrastructure comprises at least one charging parking lot having a charger plate composed of multiple inductive charging zones, each charging zone being either automatically activatable, to be activated, or activated, or alternatively being automatically deactivatable, to be deactivated, or deactivated. The vehicle is to be positioned or parked on a charging parking lot in order to carry out the charging process, only that at least one charging zone of the charging parking lot being automatically activated which is situated directly beneath the at least one inductive charging interface of the vehicle, and only this at least one activated charging zone being adapted to create a magnetic field in order to transfer electrical energy to the at least one inductive charging interface of the vehicle situated above it.

In one embodiment, the charging infrastructure has a canopy, usually at least one roof, which is arranged above the at least one charging parking lot or on top of the at least one charging parking lot and protects it against the elements. The at least one roof may span at least one charging parking lot.

In another embodiment, the charging infrastructure comprises solar cells or solar panels and storage batteries, the solar cells being adapted to convert the light of the sun into electrical energy, while the storage batteries are adapted to store the electrical energy of the solar cells and provide it to vehicles when carrying out charging processes. The solar cells may be arranged on the at least one roof.

The charging infrastructure comprises at least one communication module, which is adapted to communicate with a vehicle or a communication module situated inside it, with a terminal device, such as a smartphone, or a communication module of a user of the vehicle situated inside it, and/or with a database or a server, which is associated with the charging infrastructure, usually making use of electromagnetic waves in radio-based or wireless manner. At least one communication module of the vehicle is situated at or on a top side and/or a chassis, but not in, at, or on the bottom side of the vehicle.

The charging infrastructure may have at least one lighting fixture, i.e., a lamp and/or streetlight as a light source or luminous module, which is attached to a column and/or a pole. The at least one communication module is integrated in the lighting fixture, the column for the lighting fixture, and/or in the canopy and is physically separate from the at least one charging parking lot. Thus, it is possible to mitigate interference phenomena between a charging induction current created by the activated charging zones during the charging process and the communication modules. The communication modules of the charging infrastructure and the vehicle or the terminal device may communicate at the same time while the charging process is being performed. It is not necessary to halt the charging process performed with the charging zones and/or to minimize or switch off the charging induction being provided, in order for the communication modules to exchange signals with data via electromagnetic waves.

The method according to an embodiment of the invention described herein is designed to perform an electrical charging process for a vehicle, such as a motor vehicle, having at least one inductive charging interface on its bottom side. It makes use of a charging parking lot having a charger plate composed of multiple inductive charging zones, where each charging zone can either be automatically activated or automatically deactivated, even for itself alone, and for each charging zone to select either an active or switched on or a passive or switched off operating state. In order to perform the charging process, the vehicle is parked on the charging parking lot. Furthermore, only that at least one charging zone of the charging parking lot is activated which is or has been demonstrably situated directly beneath the at least one inductive charging interface of the vehicle. Moreover, a magnetic field is created by the at least one activated charging zone to transfer electrical energy to the at least one inductive charging interface of the vehicle situated above it.

In some embodiments, the proposed charging infrastructure comprises at least one proposed charging parking lot. The method described herein may be carried out for at least one vehicle with at least one charging parking lot and/or with the proposed charging infrastructure. When performing a charging process for a vehicle, the electrical energy is transferred inductively from the activated charging zones in the charging parking lot to the traction battery of the vehicle. The traction battery of the vehicle is adapted to provide an electric machine of the vehicle with electrical energy for the driving or propelling of the vehicle. Thanks to the designing of a respective charging parking lot with either activatable or deactivatable charging zones, a magnetic field which is physically bounded in terms of its area is provided in modular fashion for the at least one inductive charging interface of the vehicle, which acts only on the at least one inductive charging interface. Since the charging process is done inductively, no charging cable is required.

In one embodiment of the method, a usually perpendicular projection of the at least one inductive charging interface of the vehicle onto the charging zones and thus onto a field of charging zones of the charger plate is determined. If the charging zones are located in the subfloor, the perpendicular projection is also mapped onto the subfloor. A check is made to see which charging zone is encompassed by this perpendicular projection, whereupon that charging zone will be activated. It will be determined which charging zones are present in the subfloor next to the perpendicular projection of the at least one charging interface on the charging parking lot. At least one such nearby charging zone is or will be deactivated or remain deactivated during the charging process. As a rule, all charging zones are generally automatically activated or switched off where there is no vehicle located on the charging parking lot. However, once a vehicle has been parked on it and the position of the at least one charging interface is or has been determined relative to the charging zones, only the charging zones situated directly underneath it will be activated and switched on, all others remaining switched off.

With the charging parking lot, the charging infrastructure, and the method, a super simple charging (SSC) of an electrical vehicle is possible. It is possible to identify a vehicle which is to be charged by at least one further camera, which is associated with the charging infrastructure as a further optical sensor, for example being arranged on the canopy, and/or by the at least one communication module and/or to authorize it for the charging process.

It is possible for at least one communication module of the charging infrastructure which to communicate with at least one communication module of a vehicle and/or with a terminal device of a user of a vehicle, and also a communication is possible between the database and the vehicle and/or terminal device. With the at least one further optical sensor, for example on the canopy, a video monitoring of vehicles and their drivers is possible, among other things. Furthermore, with the at least one further optical sensor it is possible to identify the actual position and/or the actual spatial orientation of the vehicle, usually relative to at least one charging parking lot, and to deduce from this the usually position-dependent suitability of the vehicle for charging. A defined nominal position is provided for the vehicle relative to the charging zones. If the actual position deviates from the nominal position, it is possible to ask the driver to situate the vehicle in the nominal position. If, for example, it is determined that the vehicle has been parked not parallel to a longitudinal direction of the charging parking lot, but instead transversely to this, the user can be told to reposition the vehicle in order to make the charging process possible.

Moreover, it is possible with the at least one further optical sensor and the database to identify the vehicle, for example with the aid of its license plate, and the driver of the vehicle, for example by visual recognition, as long as this is legally allowed at a location of the charging infrastructure in a country. Thus, alterations, tampering and/or any vandalism at the charging infrastructure can also be identified.

Thanks to the use of the database or the server of the charging infrastructure, information about the servicing and/or performing of the charging process with the charging infrastructure is displayed to the vehicle and/or terminal device, such as a smartphone. With the database, a documentation of the charging process is possible. Furthermore, the database also provides the vehicle or its user with a billing for the electrical energy transferred during the charging process.

Thanks to the canopy, the user comfort can also be enhanced. The at least one optical sensor, at least one communication module and/or at least one further luminous module can be arranged at one edge of the at least one roof and/or underneath it.

### BRIEF DESCRIPTION OF THE SEVERAL VIEWS OF THE DRAWINGS

Embodiments are shown in the drawing and shall be described schematically and at length with reference to the drawings.

FIGS. 1a and 1b show in schematic representation an embodiment of the charging infrastructure comprising multiple embodiments of a charging parking lot, which are configured to carry out an embodiment of a method for performing an electrical charging process for a vehicle.

### DETAILED DESCRIPTION

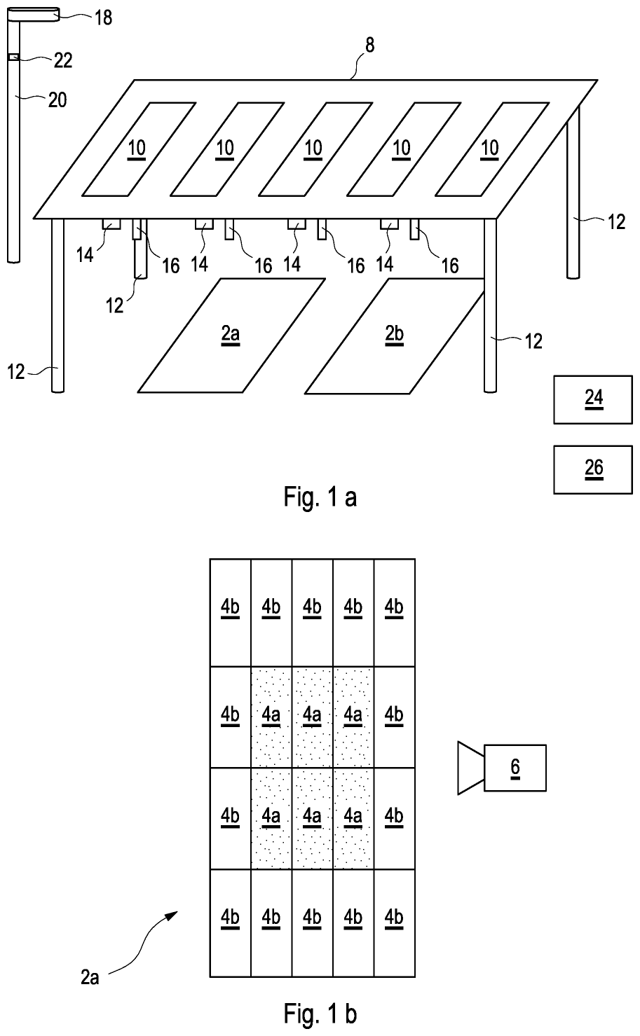

FIGS. 1a and 1b are described in connection with each other. The same reference numbers are given to the same components.

The embodiment of the charging infrastructure shown schematically in FIG. 1a comprises as its components multiple embodiments of a charging parking lot 2a, 2b, arranged in a subfloor level with the ground, one of these charging parking lots 2a being shown schematically by itself in FIG. 1b.

Each ground-level charging parking lot 2a, 2b here comprises a field of multiple, namely, m*n charging zones 4a, 4b, which are arranged here in a lattice next to each other in m columns and n rows, where m has a value of 5, for example, and n has a value of 4, for example.

When implementing an embodiment of a method for performing an electrical charging process, an electrical drive or traction battery of a not otherwise depicted vehicle, such as a motor vehicle, is charged. For this, the vehicle is at first positioned on a selected charging parking lot 2a, 2b. With a camera 6 as the optical sensor, each charging parking lot 2a, 2b being associated with at least one such camera 6, a check is made to see how an inductive charging interface is situated on, in and/or at a bottom side of the vehicle, facing the subfloor, relative in space to the charging zones 4a, 4b of the charging parking lot 2a, 2b.

It is possible for a position of the charging interface on, in and/or at the bottom side to be indicated by optically recognizable markings, which optically distinguish the charging interface and/or its position from other components on, in and/or at the bottom side of the vehicle. The position of the charging interface may be recognized by the camera 6 with the aid of the markings. Alternatively or additionally, each charging parking lot 2a, 2b may be associated with at least one further sensor, such as a Hall sensor, which is adapted to detecting a magnetic field. For the alternative or supplemental recognition of the position, the charging infrastructure may send a signal to the vehicle by at least one communication module 16, 22 to be described in the following, for example radio data, inquiring as to whether it is possible for the charging interface to create a magnetic field for a definable period of time, lasting for at most 5 or 10 seconds, for example, and being detected by the sensor adapted to doing so, from which the position of the charging interface is recognized in turn. Regardless of whether the position is recognized optically and/or magnetically, a spatial positioning relative to the charging zones 4a, 4b of the particular charging parking lot 2a, 2b is determined.

Furthermore, the charging interface of the vehicle is geometrically projected onto the charging parking lot 2a, 2b, taking into account its physical extension and/or position on, in and/or at the bottom side of the vehicle. Furthermore, it is determined which charging zones 4a among all the charging zones 4a, 4b are situated under or beneath the charging interface, and which further charging zones 4b are situated nearby, i.e., not under or beneath the charging interface.

In the case of the charging parking lot 2b of FIG. 1b, the charging zones 4a in the second, third, and fourth column in the second and third row are situated beneath the charging interface of the vehicle and will furthermore be activated and/or switched on. On the other hand, all other charging zones 4b of the charging parking lot 2b, here, all the charging zones 4b of the first row, in the second and third line the respective charging zone 4b in the first and last column, and all the charging zones 4b of the fourth line are situated next to the charging interface and will be deactivated or switched off. Furthermore, only the activated charging zones 4a directly beneath the charging interface of the vehicle will create a magnetic field, by which electrical energy will be transferred from these activated charging zones 4a to the charging interface of the vehicle, and this electrical energy will be further stored in the traction battery of the vehicle and provided to an electric machine during the driving of the vehicle in order to propel the vehicle.

By partitioning a respective charging parking lot 2a, 2b into multiple charging zones 4a, 4b, arranged in a lattice pattern, for example, where each charging zone 4a, 4b can be individually activated or deactivated, also independently of at least one further charging zone 4a, 4b, it is possible to establish in modular fashion an effective charging area for the inductive charging interface of the vehicle, taking into account the size and/or area of the charging interface, and to adapt it directly to the charging interface of the particular vehicle, i.e., using the position of the charging interface relative to each charging zone 4a, 4b of the charging parking lot 2a, 2b.

For the additional determination of the charging zones 4a, 4b to be activated and deactivated, it is possible to monitor the charging current for each individual charging zone 4a, 4b. If a charging zone 4a, 4b will not make any contribution to increasing the charging current, it can be reduced in power or possibly be switched off or deactivated. At the start of the charging process, it is possible to activate at first only one charging zone 4a which is situated directly beneath the charging interface of the vehicle. The charging current will be measured for this first activated charging zone 4a. Depending on this, it is possible to activate or add in further nearby charging zones 4a. By measuring the charging current, it is possible to determine more precisely the charging zones 4a which are required and need to be activated for the charging process and also the charging zones 4b to be deactivated.

As shown by FIG. 1a, the charging parking lots 2a, 2b are arranged under a roof 8 of the charging infrastructure and thus housed accordingly. On this roof, multiple solar cells 10 are arranged. Furthermore, multiple columns 12 are provided here as supports for the roof 8. On a bottom side of the roof 8, multiple cameras 14 are arranged for monitoring the charging parking lots 2a, 2b and the vehicles being charged with them. Moreover, multiple communication modules 16 are arranged on the roof 8, exchanging signals with data and/or information with communication modules in vehicles or terminal devices of users or drivers of the vehicles, making use of electromagnetic waves. Furthermore, the charging infrastructure comprises a further column 20 or pole, at the upper end of which is arranged a lamp or streetlight as the lighting fixture 18. In the column 20 there is situated an additional communication module 22, which is adapted to likewise exchange signals with data by electromagnetic waves with a central server 24 or a corresponding database, and also an antenna for remote data transmission integrated in a communication module of a vehicle and/or a terminal device.

Furthermore, this server 24 is associated with the charging infrastructure. It is possible for this server 24 to be connected to multiple embodiments of charging infrastructure with charging parking lots 2a, 2b, forming a network of charging infrastructure. In this case, charging processes for vehicles and/or all the charging infrastructure will be centrally administered, monitored, and/or verified through the server 24 for a charging system (a super simple charging (SSC) system), the charging system encompassing and/or networking all charging structures at different locations.

Moreover, the charging infrastructure here comprises a storage battery 26 or a corresponding battery. Light from the sun is converted by the solar cells 10 into electrical energy and stored in the storage battery 26. Furthermore, the electrical energy stored in the storage battery 26 is provided during a charging process, carried out through a charging parking lot 2a, 2b, to a vehicle being charged. Furthermore, the charging infrastructure can have an electrical connection to a power grid of an energy provider, from which the charging infrastructure draws electrical energy to perform a respective charging process, while the charging infrastructure can also feed electrical energy generated by the solar cells 10 into the power grid.

In order to carry out a charging process, a driver drives with his vehicle to the charging infrastructure and parks his vehicle on a charging parking lot 2a, 2b. In another embodiment, it is possible for a human/machine interface of the vehicle and/or the terminal device of the vehicle configured as a smartphone, for example, to provide positioning aid for the vehicle relative to a charging parking lot 2a, 2b. It is possible for the driver himself to park the vehicle on the charging parking lot 2a, 2b. Alternatively, it is also possible for the vehicle to be remotely controlled via the communication modules 16 of the charging infrastructure and parked automatically on a charging parking lot 2a, 2b.

Furthermore, the vehicle is identified by the cameras 14, usually with the aid of its license plate. It is also possible to recognize a vehicle type and/or the driver by making use of artificial intelligence of the charging infrastructure and images taken by the cameras 14 as sensors, arranged on and/or in the canopy. Different evaluation methods are generally used for pictures taken by the cameras 14 of vehicles, in order to recognize a vehicle and possibly also its driver in a more accurate and robust manner. Alternatively, or additionally, a wireless and/or radio-based identification of a vehicle is also possible, the final identity of the vehicle (the vehicle ID) being sent by a communication module of the vehicle, by radio and/or by near-field communication, RFID or radio-frequency identification, for an identification by electromagnetic waves, to a communication module 16, 22 of the charging infrastructure.

The information and/or data on vehicles and drivers registered by the cameras 14 are compared against the central server 24, which keeps a record as to whether a vehicle and/or a driver is authorized to perform a charging process and if so, under what conditions. For this, it is also possible to keep a charging contract with the charging infrastructure and/or the charging system in the server 24 for each vehicle and/or each driver. Moreover, the driver is authorized via the server 24 to carry out the charging process after identification of the vehicle.

From a communication module 16, 22 of the charging infrastructure, at least one communication module of the vehicle and/or a terminal device of the driver of the vehicle is provided with information, for example, through an application (app), as to whether the vehicle can be parked on one of the charging parking lots 2a, 2b or whether a previously described inductive charging process can be performed for the vehicle, and if so under which conditions, i.e., also at what price. The driver can decide for himself whether he wants to only park his vehicle or also charge it electrically, in which case the driver confirms his decision with a terminal device, which relays the outcome of the decision in turn to the communication module 16, 22 of the charging infrastructure.

It is possible in this regard for the driver to also store in memory a defined or definable policy stating that the vehicle should always be charged automatically whenever it is parked or positioned on a charging parking lot 2a, 2b. It is also possible for the driver to stipulate a limit or an upper bound on the price of the electrical energy being charged, and then a charging process can only be performed automatically if the price is less than the limit provided for this.

Once the vehicle has been authorized, the server 24 generally allows automatically the performing of the inductive charging process through that charging parking lot 2a, 2b on which the vehicle has been parked. Once the traction battery of the vehicle has been sufficiently charged, e.g., fully charged, the driver can leave the charging parking lot 2a, 2b with his vehicle, being provided with information as to how much the charging process cost in total through his terminal device with the application. The end of the charging process is recognized, for example, when the vehicle is started and removed by its driver from the charging parking lot 2a, 2b.

If the driver only wants to park his vehicle on a charging parking lot 2a, 2b without carrying out a charging process, and the vehicle is blocking the charging parking lot 2a, 2b, a corresponding warning will be relayed to the vehicle and/or the terminal device of the driver, reporting this fact. If the driver does not remove the vehicle, it is possible that a penalty will be assessed.

German patent application no. 10 2022 109968.7, filed Apr. 26, 2022, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging parking lot for performing an electrical charging process for a vehicle, comprising:
at least one inductive charging interface, wherein the charging parking lot has multiple inductive charging zones, and each charging zone is either activatable or deactivatable,
wherein the vehicle is to be parked on the charging parking lot to perform the charging process,
wherein only that at least one charging zone of the charging parking lot is to be activated which is situated directly beneath the at least one inductive charging interface of the vehicle, and
wherein the at least one activated charging zone is adapted to generate a magnetic field for the transfer of electrical energy to the at least one inductive charging interface of the vehicle.

2. The charging parking lot according to claim 1, wherein the charging zones are arranged in lattice pattern in a subfloor.

3. The charging parking lot according to claim 1, further comprising at least one sensor, wherein the at least one sensor is adapted to detect which at least one charging zone is situated directly beneath the at least one inductive charging interface of the vehicle.

4. A charging infrastructure for performing electrical charging processes for vehicles, comprising:
at least one inductive charging interface,
wherein the charging parking lot has multiple inductive charging zones, and each charging zone is either activatable or deactivatable,
wherein a vehicle is to be parked on a charging parking lot in order to perform the charging process,
wherein only that at least one charging zone of the charging parking lot is to be activated which is situated directly beneath the at least one inductive charging interface of the vehicle,
wherein the at least one activated charging zone is adapted to generate a magnetic field for the transfer of electrical energy to the at least one inductive charging interface of the vehicle.

5. The charging infrastructure according to claim 4, further comprising a canopy for the at least one charging parking lot.

6. The charging infrastructure according to claim 4, further comprising solar cells and at least one storage battery, wherein the solar cells are adapted to convert light into electrical energy, wherein the at least one storage battery is adapted to store the electrical energy of the solar cells and provide it to at least one vehicle when performing a charging process.

7. The charging infrastructure according to claim 4, further comprising at least one communication module, which is adapted to communicate with a vehicle, with a terminal device of a user of a vehicle and/or with a server.

8. The charging infrastructure according to claim 4, further comprising at least one lighting fixture.

9. A method for performing an electrical charging process for a vehicle having at least one inductive charging interface, with a charging parking lot having a charger plate composed of multiple inductive charging zones, wherein each charging zone is either activated or deactivated, the method comprising:
parking the vehicle on the charging parking lot in order to perform the charging process;
activating at least one charging zone of the charging parking lot situated directly beneath the at least one inductive charging interface of the vehicle; and
generating a magnetic field for the transfer of electrical energy to the at least one inductive charging interface of the vehicle by the at least one activated charging zone.

10. The method according to claim 9, further comprising deactivating at least one further charging zone situated next to a projection of the at least one inductive charging interface of the vehicle on the charging parking lot.
